(19) United States
(12) Patent Application Publication
(10) Pub. No.: US 2007/0013181 A1
(43) Pub. Date: Jan. 18, 2007

(54) Adjustable instrument cluster

(75) Inventor: Thomas Heck, Mainz-Laubenheim (DE)

Correspondence Address: COHEN, PONTANI, LIEBERMAN & PAVANE, 551 FIFTH AVENUE, SUITE 1210, NEW YORK, NY, 10176, US

(73) Assignee: Siemens Aktiengesellschaft

(21) Appl. No.: 11/484,440

(22) Filed: Jul. 11, 2006

(30) Foreign Application Priority Data
Jul. 13, 2005 (DE) 10 2005 032 706.0

(51) Int. Cl. B62D 1/18

(52) U.S. Cl. 280/775; 74/493

(57) ABSTRACT

An instrument cluster in a motor vehicle includes a housing in which display elements are arranged and face a driver. To ensure good visibility of the display elements to the driver, the housing of the instrument cluster is designed to be adjustable in its height and in its alignment toward the driver.

### BACKGROUND OF THE INVENTION

The invention relates to an instrument cluster in a motor vehicle with a housing and display elements arranged in the housing which face a driver.

Information about the status of the motor vehicle is conveyed to the driver via the display elements arranged in the housing of the motor vehicle, such as for example speedometer, rpm indicator, temperature and fuel gauges. This may be carried out by analog pointer and bar graph displays or via alphanumeric displays.

It is in this case important for the driver's head to move as little as possible, or even not at all, during the journey, in order to see the display elements. Thus, as a result, the driver only requires a brief moment to find out about the status of his or her own vehicle, whilst in the remaining time the driver is able to concentrate fully on the traffic conditions outside the vehicle.

Generally, the instrument cluster is arranged in current vehicles such that the driver looks through the upper region of the steering wheel when looking at the display elements. The angle of view of the driver and therefore also the visibility of the display elements within the instrument cluster changes, however, depending on the height of the driver. It is possible that the driver then has to move his or her head in order to be able to see all the display elements.

To this end, DE 198 14 904 A1 proposes to provide one of the display elements in an instrument cluster, namely a freely programmable display, with angular adjustment. This one display element may therefore be adapted to the angle of view of the driver.

When adjusting the seat position of the driver or even the height and/or longitudinal position of the steering wheel, the view of the instrument cluster may, however, be partially obscured by areas of the steering wheel. If this affects the display elements, which are not designed to be angularly adjustable, the driver still has to move his or her head in order to see them.

### SUMMARY OF THE INVENTION

An object of the present invention is to provide an instrument cluster such that display elements arranged in a housing of the instrument cluster are always easily visible to the driver.

This object is achieved by an instrument cluster of which the housing is adjustable in its height and in its alignment toward the driver.

In this manner, all the display elements arranged in the housing of the instrument cluster are moved and may therefore be optimally adapted to the angle of view of the driver and the position of the steering wheel.

The housing may therefore be adjusted mechanically or even electromotively, it being advantageous in the two embodiments if the housing of the instrument cluster is moved with the steering wheel when the steering wheel, arranged between the instrument cluster and the driver, is adjusted. In this manner, the alignment of the viewing aperture in the steering wheel over the instrument cluster is maintained, so that the possibility of the instrument cluster being obscured by the steering wheel parts is reduced.

Alternatively, however, separate means for mechanical or electromotive adjustment may also be provided on the housing of the instrument cluster, which the driver may use separately to adjust the height of the instrument cluster and to pivot said instrument cluster.

With a mechanical adjustment device, it is provided in an embodiment of the invention that the housing of the instrument cluster is mechanically connected to the steering wheel via a drive element, such that the housing performs all the movements of the steering wheel, with the exception of the steering movement. In this embodiment, the use of materials is particularly minimal. In particular, the addition of adjusting motors is not necessary and no electrical adjustment energy is required. Instead of which, the manual adjustment of the steering wheel carried out by the driver is directly translated into a corresponding movement of the housing of the instrument cluster.

In a development, the housing of the instrument cluster may be displaced in the direction of the driver in a linear guide installed in the motor vehicle at an angle to the floor of the vehicle and rotatably mounted about its parallel axis pointing obliquely toward the driver. By the longitudinal displacement in the direction of the driver, the height and distance of the instrument cluster from the driver may therefore be varied and by the rotary motion the angle of inclination and thus the alignment toward the driver may be adjusted. The instrument cluster and the display elements arranged therein may therefore be optimally adapted to the head height and the viewing direction of the driver.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1a is a schematic arrangement of a steering wheel, an instrument cluster and a mechanical adjustment device according to the invention;

FIG. 1b is a schematic side view of the arrangement of FIG. 1a in an initial position;

FIG. 2 is a schematic side view of the arrangement of FIG. 1 after adjustment of the steering wheel;

FIG. 3 is a schematic side view of the arrangement of FIG. 2 after displacement of the instrument cluster;

FIG. 4 is a sectional view of the instrument cluster of FIG. 1a and a portion of the adjustment device.

### DETAILED DESCRIPTION OF THE PRESENTLY PREFERRED EMBODIMENTS

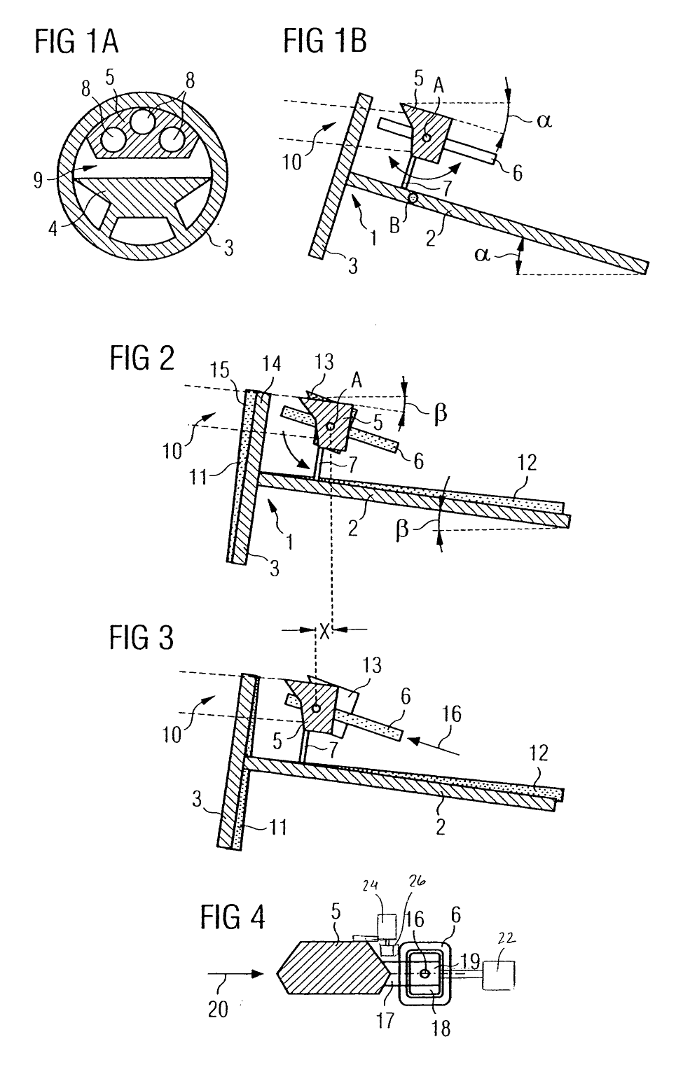

A steering wheel 1, consisting of a steering column 2, a steering wheel rim 3 and a steering wheel hub 4, a housing 5 of an instrument cluster and a mechanical adjustment device, consisting of a linear guide 6 and a drive element 7 are shown in FIGS. 1a and 1b. In this connection, FIG. 1a shows the front face of the steering wheel visible to the driver and the housing 5 of the instrument cluster. In this example, three display elements 8 are arranged in the housing 5 which display state variables of the motor vehicle to the driver. In the arrangement of the steering wheel 1 and the housing 5 to one another, shown in FIGS. 1a and 1b, the three display elements 8 are fully visible through the viewing aperture 9 between the steering wheel rim 3 and the steering wheel hub 4 and thus may be read easily. The field of view and the viewing direction of the driver when reading the display elements 8 is made clear by the viewing passage 10.

The housing 5 is rotatably mounted about the pivot A in the linear guide 6. The axis of rotation therefore extends parallel and transversely to the driver seated in front of the steering wheel 1. Moreover, the housing 5 may be longitudinally displaced along the linear guide 6. The housing 5 and the steering column 2 are, in this example, aligned in the initial position shown in FIG. 1b at the same angle a to the motor vehicle.

Proceeding from the initial position of FIG. 1b, the driver adjusts the steering wheel 1 by pressing it downwards. The rigidly designed drive element 7 which mechanically connects the housing 5 and the steering column 2 to one another, ensures that the steering wheel 1, together with the housing 5, rotates about the pivot A by the same angle, as shown in FIG. 2. Accordingly, after the adjustment of the steering wheel the steering column 2 and the housing 5 adopt the same reduced angle β to the motor vehicle.

By way of comparison, a further steering wheel with a steering wheel rim 11 and a steering column 12 and a further housing 13 are additionally shown in FIG. 2. This further steering wheel and the further housing 13 are not connected to one another. They are located in the same initial position as the steering wheel 1 and the housing 5 in FIG. 1b and, proceeding therefrom, the steering wheel 1 has also been pressed downwards. The driver has moved the steering wheel rim 11 to a height which is comfortable and which is the same as the steering wheel rim 3. As the drive element 7 is missing, the further housing 13 has remained in its initial position and the further steering wheel has not been rotated about the pivot A but about the pivot B (see also FIG. 1). As the driver has not adjusted the seat, the viewing passage 10 has remained the same. The upper region 14 and/or 15 of the steering wheel rim 3 and/or 11 has now been moved into this viewing passage 10. With the housing 13 not being moved therewith, the upper display element 8 is therefore to a large part obscured by the steering wheel rim 11. This obscuring is reduced when the housing 5 is moved with the steering column 2.

In order to be able to see the upper display element 8 again fully, the driver now displaces the steering wheel 1 along the linear guide 6 in the direction of the arrow 16. Due to the angled position of the linear guide 6 a further height adjustment is simultaneously achieved by the longitudinal offset x which results in the viewing aperture 9 being moved in the direction of the viewing passage 10 and/or in the upper region of the steering wheel rim 3 being moved out of the viewing passage 10. As a result, all three display elements 8 are again fully visible to the driver.

FIG. 4 shows a sectional view of the housing 5 and the linear guide 6 from the direction of the arrow 16. The housing 5 is connected via a spacer 17 to a bearing arrangement within the linear guide 6, the bearing arrangement consisting of a guide body 18 and a pivot bearing 19. The guide body 18 is thus configured to be displaceable in the longitudinal direction (arrow 16) of the linear guide 6 and the pivot bearing 19 allows a pivoting motion about the pivot A and/or the axis of rotation 20. The adjustment of the housing 5 may be made mechanically by user adjustment of the steering wheel 1. Alternatively, the adjustment of the housing 5 may be electromotively. For this purpose, a motor 22 may be connected to the pivot bearing 19 for pivoting the housing 5 about the pivot A and/or the axis of rotation. A further motor 24 may be arranged on the housing for operating, for example, a rack and pinion connection 26 to move the housing 5 longitudinally along the linear guide 6.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We I claim:

1. An instrument cluster in a motor vehicle, comprising a housing and display elements arranged in said housing which face a driver, wherein said housing is movably mountable on a device in the motor vehicle such that said housing is adjustable in height and in alignment toward the driver.

2. The instrument cluster of claim 1, wherein said housing is mechanically adjustable.

3. The instrument cluster of claim 1, wherein said housing is electromotively adjusted.

4. The instrument cluster of claim 2, further comprising an adjustable steering wheel arranged between the driver and said instrument cluster, said housing being connected to said adjustable steering wheel such that said housing of said instrument cluster is moved with said steering wheel in response to an adjustment of said steering wheel.

5. The instrument cluster of claim 2, further comprising an adjustable steering wheel arranged between the driver and said instrument cluster, and a drive element mechanically connecting said housing of said instrument cluster to said steering wheel such that said housing performs all the movements of said steering wheel, with the exception of the steering movement.

6. The instrument cluster of claim 1, wherein said device on which said housing is movably arranged comprises a linear guide installed in the motor vehicle at an angle to the floor of the vehicle and pointing obliquely toward the driver such that said housing is displaceable in a direction of the driver and is rotatably mounted about an axis perpendicular to said linear guide.
